(19) United States
(12) Patent Application Publication
(10) Pub. No.: US 2022/0180007 A1
(43) Pub. Date: Jun. 9, 2022

(54) CENTRALIZED ACCESS CONTROL OF INPUT-OUTPUT RESOURCES

(71) Applicant: Hewlett-Packard Development Company, L.P., Spring, TX (US)

(72) Inventors: Tsue-Yi Huang, Taipei City (TW); Chia-Cheng Lin, Taipei City (TW); Heng-Fu Chang, Taipei City (TW); Nung-Kai Chen, Taipei City (TW)

(73) Assignee: Hewlett-Packard Development Company, L.P., Spring, TX (US)

(21) Appl. No.: 17/297,780

(22) PCT Filed: Aug. 26, 2019
(86) PCT No.: PCT/US2019/048067

§ 371 Date: May 27, 2021

(51) Int. Cl. G06F 21/82; G06F 21/60; G06F 21/57; G06F 21/31

(52) U.S. Cl. CPC G06F 21/82; G06F 21/604; G06F 21/31; G06F 21/575; G06F 21/572

(57) ABSTRACT

Examples of of centralized access control of an input-output (I/O) resource of a computing device are described herein. In an example, access rights available for a user for the I/O resource are determined based on user identification data, and access to the I/O resource to the user is controlled centrally based on the available access rights associated with the user.

### BACKGROUND

A computing device may use input/output (I/O) operations to achieve various functionalities to be executed. For instance, the I/O operations may be executed between a memory and one or more devices connected to the computing device through the computing device's I/O resources, such as I/O ports including a universal serial bus (USB) port.

### BRIEF DESCRIPTION OF FIGURES

The detailed description is provided with reference to the accompanying figures, wherein:

FIG. 1 illustrates a network environment implementing centralized access control of input-output (I/O) resources, according to an example;

FIG. 2 illustrates a schematic of an access control (AC) device for centrally controlling I/O resources, according to an example;

FIG. 3 illustrates a schematic of a computing device having I/O resource(s) that is centrally access-controllable, in accordance with an example;

FIG. 4 illustrates a flow diagram showing coordinated operation between the AC device and the computing device to achieve centralized access control of the I/O resources of the computing device, according to another example;

FIG. 5 illustrates a network environment using a non-transitory computer readable medium for centralized access control of the I/O resource(s) of the computing device, according to one other example.

It should be noted that the description and the figures are merely examples of the present subject matter and are not meant to represent the subject matter itself. Throughout the drawings, identical reference numbers designate similar, but not identical, elements. The figures are not to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

Access to the I/O resources may have to be controlled, for example, in an organizational setup where different personnel at different levels may be provided with different levels of access. For instance, an IT administrator may have access to all the I/O resources while a trainee may have access to none. Such variations in the access may be defined in an access policy and the access control capability, based on the access policy, may be built into the startup operation of the computing device. For instance, the Basic Input-Output Systems (BIOS) setup menu or the BIOS Configuration Utility (BCU) in the operating system of the computing device may boot the I/O resources with the access control. Accordingly, the computing device can determine during startup, the level of access to the I/O resources to be provided and, accordingly, regulate the access to the I/O resources.

There might be situations where the computing device may have to be provided on an urgent basis, and the change in access control may have to be done in a short duration. For example, a computing device may be damaged and may have to be replaced immediately, or an employee who otherwise uses a desktop computer may have to travel to a client site and may have to carry a laptop, or a trainee using a computing device with all I/O ports locked may have to use a USB port. In such cases, based on the access to be granted, the access control may have to be configured in the computing device by IT personnel which may involve considerable time for setup. In urgent situations, the computing device without adequate access control implemented therein may have to be issued, which may leave the computing device vulnerable. Otherwise, backup computing devices may have to be maintained, for example, with few backup computing devices configured with access control at each level, which may be a considerably costly option.

Examples of centralized access control of input-output (I/O) resources of a computing device are described herein. The present subject matter describes, as an example, control of the I/O resources of a computing device in a client-server architecture, where the control of the I/O resources of multiple clients, referred to as computing devices, are controlled centrally by a single server, referred to as a central access control device. Therefore, various user access levels can be defined which can allow differential use of the limited I/O resources, such as enabling or disabling the USB port, USB Type-C port, the local area network (LAN) controller/port, and Bluetooth, on the computing device.

In one example, rules may be prescribed to map a plurality of user access levels and access rights associated with each user access level, for instance, at the central access control device, for an organization. The user access levels may include, for example, IT administrator, Managing Director, Head of Accounts, mid-level employee, and trainee. The access rights may indicate a type of access to a user to the input-output (I/O) resource of the computing device to the personnel at the associated user access level. For instance, read-write access to a USB port may be available at an IT administrator level, read access may be available at the level of a mid-level employee, and no access may be available at trainee level.

The computing device may transmit user identification data of a user attempting to access the I/O resource of a computing device. In an example, the computing device may obtain the user identification data of the user when the user logs into the computing device for starting-up and booting the computing device. For instance, at the time of booting the operating system, the computing device may prompt the user to log in using predefined credentials, based on which the computing device can identify the user and, accordingly, retrieve user identification data for the identified user. The central access control device, upon receipt of the access request, can determine the access rights available for the identified user, for instance, based on the user access level identified, and based on the mapping of the user access levels and the access rights. The central access control server can transmit to the computing device the available access rights associated with the user, as determined above, and accordingly, centrally control access to the I/O resources associated with the computing device. In turn, upon receipt of the information regarding the access rights, the computing device may implement the access rights received from the central access control server. In one example, the computing device may be prompted to re-boot to implement the access rights in its operating system.

Accordingly, the implementation of access policy can be implemented by maintaining the access rights in the central access control server and by making associations between user access levels, user identification data, and the access rights to I/O resources. For instance, all the users at trainee level can be identified and associated to that user access level and the access rights to the I/O resources can be linked thereto. Accordingly, during implementation of the access policy, the central access control server can obtain the user identification data, match the user access level, and implement the access policy by transmitting the associated access rights. Therefore, for urgent situations, for example, the user login credentials on a laptop can be sufficient for identifying the access rights to be transmitted to that laptop and involve considerably low time and little involvement of IT personnel. In addition, the same computing device can be used by multiple users in the organization at various levels, with quick implementation of the access policy for the given user. Further, the access control is exercised in the pre-booting phase without entering into the Advanced Configuration and Power Interface (ACPI) operating system, which means that to implement the present invention, the I/O resources in the operating system environment do not have to be changed.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

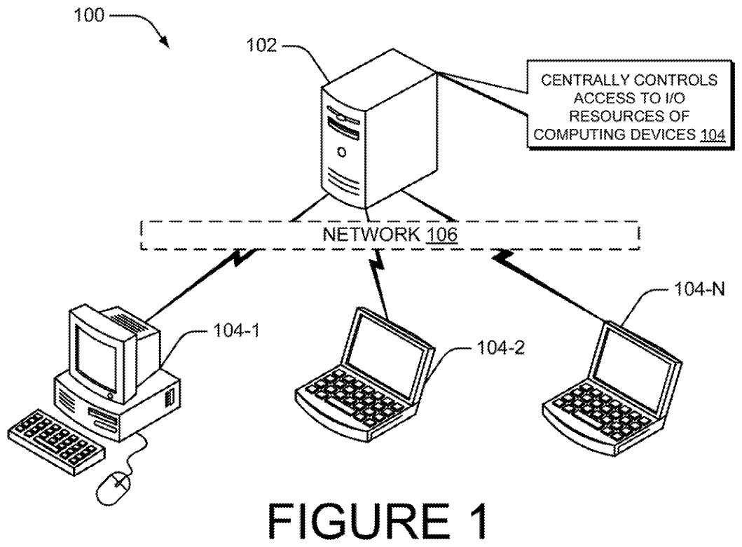

FIG. 1 illustrates a network environment 100 implementing access control of input-output (I/O) resources, according to an example of the present subject matter. In the present example, the network environment 100 includes an access control (AC) device 102 and a plurality of computing devices 104-1, 104-2, . . . 104-N, collectively referred to as computing devices 104 and individually referred to as a computing device 104, communicably coupled to the AC device 102. The computing device 104 can include an I/O resource (not shown), such as a universal serial bus (USB) port, a USB Type-C port, and a local area network (LAN) port, which can be centrally access controlled by the AC device 102. In other words, instead of the computing devices 104 applying access control to its own I/O resources, the AC device 102 can perform access control functions on the I/O resources of the computing devices 104 to allow or disallow a user of a computing device 104 access or use of the I/O resources of that computing device 104.

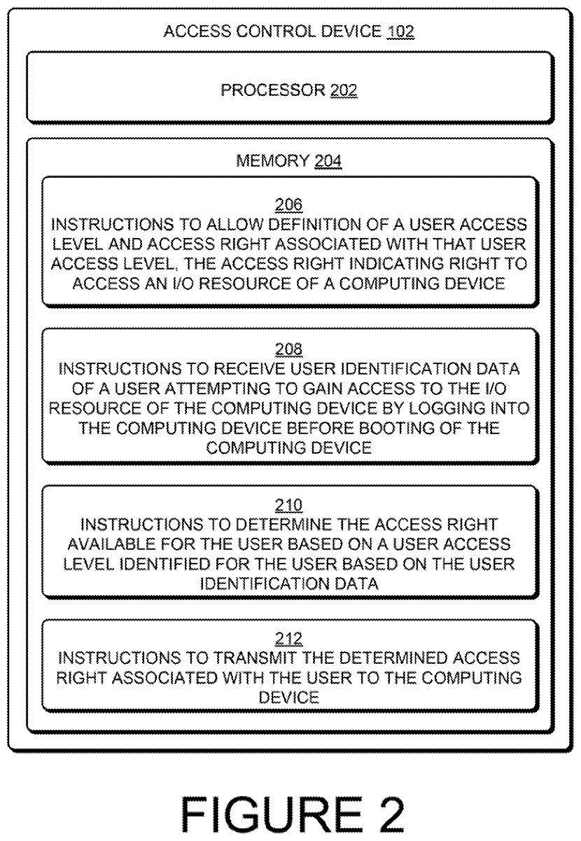

Further, the AC device 102 can be coupled to the computing devices 104 over a network 106. The network 106 may be a wireless network, a wired network, or a combination thereof. The network 106 can also be an individual network or a collection of many such individual networks, interconnected with each other and functioning as a single large network, e.g., the Internet or an intranet. The network 106 can be employed as one of the different types of networks, such as intranet, local area network (LAN), wide area network (WAN), the Internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, for providing a link between the AC device 102 and the computing devices 104, and can also include communication links for the communication between the various components in the network environment 100. The communication links between the AC device 102 and the computing devices 104 may be enabled through any form of communication, for example, via dial-up modem connections, cable links, digital subscriber lines (DSL), wireless or satellite links, or any other suitable form of communication. The operation of the AC device 102 and of the computing device 104 is discussed in detail with reference to the forthcoming FIGS. 2, 3, and 4.

FIG. 2 illustrates a schematic of the AC device 102, according to one example of the present subject matter. In the present example, the AC device 102 may be employed as any of a variety of computing devices, including, servers, a desktop personal computer, a notebook or portable computer, a workstation, a mainframe computer, a mobile computing device, and a laptop. Further, in one example, the AC device 102 may itself be a distributed or centralized network system in which different computing devices may host the hardware components, the software components, or a combination thereof, of the AC device 102. The AC device 102 can include a processor 202 and a memory 204 coupled to the processor 202.

The processor 202 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions. The memory 204 may include any non-transitory computer-readable medium including volatile memory (e.g., RAM), and/or non-volatile memory (e.g., EPROM, flash memory, Memristor, etc.). The memory 204 may also be an external memory unit, such as a flash drive, a compact disk drive, an external hard disk drive, or the like.

In operation, as mentioned above, the AC device 102 can control access to an I/O resource of the computing devices 104 connected to the AC device 102. Accordingly, the AC device 102 can be provided with the information regarding various users of the computing devices and the respective access rights that can be provided to each user.

The AC device 102 may include instructions 206 to allow definition of a user access level along with an access right associated with that user access level. For instance, the AC device 102 can allow definition of a plurality of user access levels along with access rights associated with each of the plurality of user access level. The access rights can determine rights available to a user at a the given user access level to access or use an I/O resource of a computing device. In an example, the user access levels and the associated access rights can be mapped with each other and defined for each organization. In other words, the user access levels and the associated access rights with each user access level defined for one organization are different and separate from those defined for another organization. For instance, the user access levels and the access rights may be defined for an organization, and in that organization, for a user access level named “administrator”, the access rights may be defined as “all available” indicating that at the administrator user access level, the user can have complete access including read-write access, modification access, and installation rights, etc. to all the I/O resources of the computing device 104.

In an example, the aforementioned operation of the AC device 102 can be a setup phase in which the AC device 102 is setup for achieving central access control of the I/O resources of the computing devices 104. In other words, once the AC device 102 has been setup and includes the mapping of the user access level and the associated access right, the AC device 102 may be brought online for centrally controlling the access to the I/O resources of the computing devices 104.

The processor 202 may execute the instructions 208 to receive user identification data of a user attempting to gain access to the I/O resource of the computing device 104, by logging into the computing device before the booting of the computing device 104 takes place. For example, booting of the computing device can be the starting operations of the computing device 104 in which various hardware and software components of the computing device 104 can be initialized. Based on the user identification data, the user access level of the user can be identified, and, in turn, based on the user access level so identified, the access right available for the user can be identified by executing the instructions 210. Further, the processor 202 can execute the instructions 212 to transmit the determined access right associated with the user to the computing device where the access right can be implemented. Therefore, as has been explained previously, the AC device 102 can, instead of the computing device 104, implement an access policy for an organization represented by the mapping between the user access levels and the access rights.

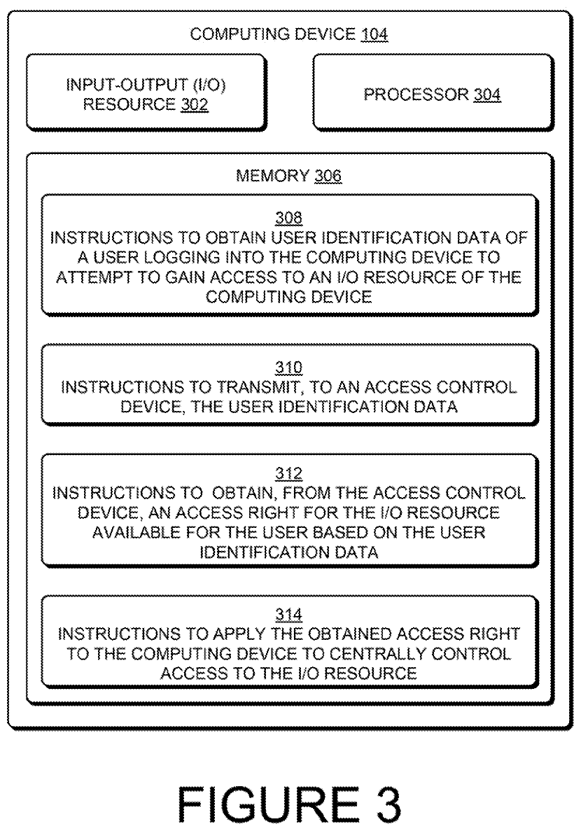

FIG. 3 illustrates a schematic of the computing device 104, in accordance with an example of the present subject matter. The computing device 104, as mentioned previously, can include I/O resource(s) 302 which is centrally access-controllable. The I/O resources 302 can include, for example, a universal serial bus (USB) port, a USB Type-C port, a local area network (LAN) port, a High-Definition Multimedia Interface (HDMI) port, an optical disk drive, and the like. In the present example, the computing device 104 may be employed as any of a variety of computing devices, including electronic book readers, cellular phones, personal digital assistants (PDAs), portable media players, tablet computers, and laptop computers.

Further, the computing device 104 can include a processor 304 and a memory 306. The processor 304 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions. The memory 306 may include any non-transitory computer-readable medium including volatile memory (e.g., RAM), and/or non-volatile memory (e.g., EPROM, flash memory, Memristor, etc.). The memory 306 may also be an external memory unit, such as a flash drive, a compact disk drive, an external hard disk drive, or the like.

In operation, the computing device 104 cooperates with the AC device 102 for implementing the access policy for a user logging into the computing device 104, for example, for the first time in a new computing device 104 or for the first time in a restored computing device 104. The processor 304 executes instructions 308, during start-up, to obtain user identification data from the user logging into the computing device and attempting to gain access to the I/O resource 302, for example, by starting-up and booting the computing device 104. Therefore, in said example, before an operating system of the computing device 104 loads and is initialized and before the computing device 104 is functional, the user identification data of the user attempting to access the I/O resource 302 is obtained, for example, to further determine whether the user is to be allowed access and the type of access that the user is to be allowed based on the predefined access policy. Accordingly, the processor executes the instructions 310 to transmit the user identification data of the user to the AC device 102. Subsequently, the processor can execute instructions 312 to obtain from the AC device 102 an access right available for the user, the access right identified based on the user identification data, for example, based on the user access level to which the user pertains and then identifying the access right available to that user access level. Further, the obtained access right is applied or implemented at the I/O resource 302 by executing instructions 314 to achieve central access control to the I/O resource 302. In an example, the obtained access right can be implemented by re-booting the computing device 104.

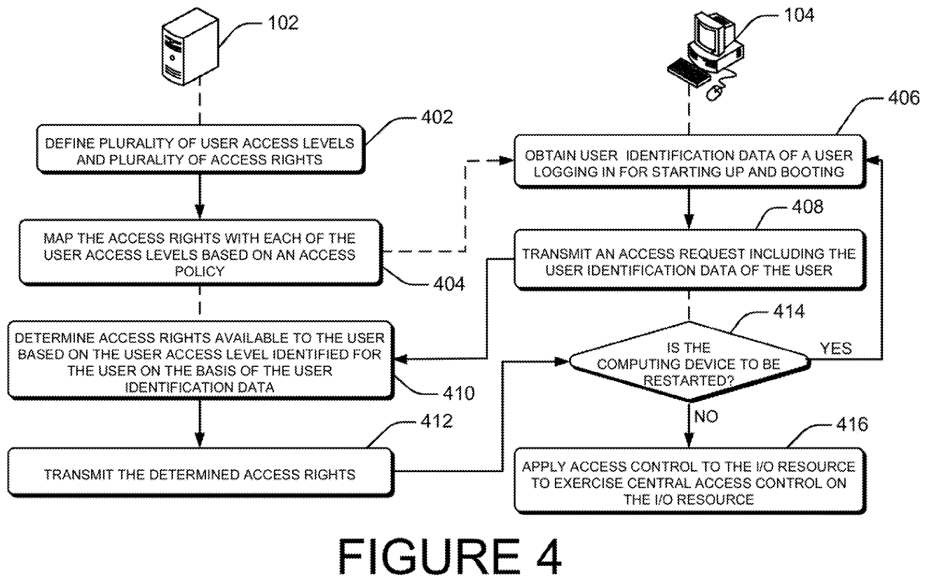

FIG. 4 illustrates a flow diagram 400 showing the coordinated operation of the AC device 102 and the computing device 104 to achieve centralized access control of one or more I/O resources 302 of the computing device 104. The flow diagram 400 for centralized access control of the I/O resources 302 may be described in the general context of computer executable instructions. Generally, computer executable instructions can include routines, programs, objects, components, data structures, procedures, engines, functions, etc., that perform certain functions or employ certain abstract data types. The flow diagram 400 may also be practiced in a distributed computing environment where functions are performed by remote processing devices that are linked through a communications network. In a distributed computing environment, computer executable instructions may be located in both local and remote computer storage media, including memory storage devices.

The order in which the blocks in the flow diagram 400 is described is not intended to be construed as a limitation, and any number of the described blocks can be combined in any order to employ the flow diagram 400, or an alternative flow diagram. Additionally, individual blocks may be deleted from the flow diagram 400 without departing from the scope of the subject matter described herein. Furthermore, the flow diagram 400 can be employed in any suitable hardware, software, firmware, or combination thereof. The flow diagram 400 is explained with reference to the AC device 102 and the computing device 104, and for the sake of brevity, the components and details associated with the flow diagram 400 described in FIG. 1, FIG. 2, and FIG. 3 are not repeated. As is seen in FIG. 4, the steps performed by the AC device 102 are aligned with the AC device 102 and the steps performed by the computing device 104 are aligned with the computing device 104, both indicated by dotted lines.

Referring to flow diagram 400, at block 402, a plurality of user access levels can be defined, at the AC device 102, along with a plurality of associated access rights for the I/O resources 302. The I/O resources 302 can include, for example, the I/O resource is one of a universal serial bus (USB) port, a USB Type-C port, a local area network (LAN) port, a High-Definition Multimedia Interface (HDMI) port, an optical disk drive, a keyboard, a network driver, and the like. Further, in one example, the user access levels can be defined for an organization and can include administrator, high-level user, such as a manager or director, a mid-level user, such as a team manager, a low-level user, such as a team associate, and a trainee. Additionally, the access rights can be defined, which may include, for instance, all read-and-write access, only-read access, no access, for the I/O resources 302.

At block 404, the defined access rights are linked and mapped to the respective user access level at the AC device 102. For example, for the administrator level user access level, all access may be available to all the I/O resources 302 of the computing device 104, whereas a user the trainee level user access level may not be provided with access to any of the I/O resources 302 except a keyboard of the computing device. Further, for other intermediate user access levels, there may be varying degrees of access rights available for accessing the I/O resources. For example, at team manager level, one USB port may have read-only access but may not have write-access, whereas at a team associate level there may not be any access to the USB ports. Accordingly, based on, for instance, the access policy of the organization, each user access level may be mapped with the corresponding access rights available to a user at that access level. In addition, the user access levels may also be mapped to each user of the organization, for example, by associating a user identification with the corresponding user access level. For instance, a name of the user may be linked with the user access level to which the user belongs.

With this, setup of the AC device 102 for performing centralized access control of the I/O resources 302 of the computing device 104 is achieved. The access rights and the user access levels for an organization in the AC device 102 can be regularly or intermittently updated by an administrator of the organization, for example, on change in the access policy for I/O resources 302 for the organization. Therefore, the central access control, as provided by the AC device 102, can provide the flexibility to the organization to implement an updated access policy as and when the update occurs, and the same can be reflected in the computing devices 104 regulated for access control by the AC device 102, as is explained in detail below. Subsequently, but not necessarily immediately (as indicated by the dotted arrow), the computing device 104 can cooperate with the AC device 102 for implementing the centralized access control of the I/O resources 302 on the computing device itself.

Further, at block 406, at the computing device 104, user identification data of a user attempting to login to the computing device 104 for starting up the computing device 104, and thereby, gain access to the I/O resources 302, can be obtained. For instance, the user identification may be obtained for the purpose of exercising centralized access control of the I/O resources 302 when the computing device 104 is powered on and the user logs into the computing device 104 for the first time. In an example, the user may login for the first time in a new computing device 104, or in an old computing device 104, for instance, used by a previous user, which has now been restored and formatted and provided to the user for fresh use. In either case, the access control has to be applied on the I/O resources 302 of the computing device 104 based on the access rights available to the user logging in, before the computing device 104 boots. For example, the user identification data can be retrieved from the login information by a Basic Input-Output System (BIOS) or a Unified Extensible Firmware Interface (UEFI) driver of the computing device 104.

Further, at block 408, the computing device 104 may send the user identification data to the AC device 102 to determine the access rights available to the user attempting to gain access to the computing device 104 and its I/O resources 302. In an example, the user identification data can be included in an access request generated by the computing device 104 in response to the obtaining of the user identification data for access to the I/O resources 302. The computing device 104 can transmit the user identification data to the AC device 102 through a pre-boot network communicator thereof, which is capable of communicating with the AC device 102 before the booting of the computing device 104. For example, the user identification data can be transmitted by the BIOS or the UEFI driver of the computing device 104. For instance, in case of the UEFI driver transmitting the information, the UEFI driver may use a Preboot eXecution Environment-capable (PXE-capable) network interface controller (NIC) to transmit the user identification data.

At block 410, at the AC device 102, the access request is processed and the access rights available to the user logged in to the computing device 104 are determined, based on the user access level identified for the user on the basis of the user identification data in the access request. As mentioned previously, the mapping of the user identification and the user access level is already provided at the AC device 102, and, in one example, the user identification data in the access request is matched against the user identification in the AC device 102 to ascertain the user access level corresponding to that user. For instance, based on the user name or the designation of the user in the organization, the user access level can be ascertained, based, in turn, on which, the access rights associated with the user can be determined.

Further, at block 412, the AC device 102 transmits back the access rights identified for the user to the computing device 104. In an example, the AC device 102 can transmit the available access rights either to the BIOS or the UEFI driver of the computing device 104. In addition, in another example, the AC device 102 may also transmit a boot initiation instruction to the computing device 104 along with the determined available access rights.

At block 414, at the computing device 104, the implementation of the access control based on the received access rights is initiated. In one example, in response to the boot initiation instructions, the computing device 104 may determine as to whether it is to be restarted or rebooted or not, afresh so that the received access rights can be applied to exercise access control on the I/O resources 302 of the computing device 104. In another example, in response to the receipt of the access rights, the computing device may auto-restart to boot the computing device 104.

Coming back to the example where the determination regarding rebooting the computing device 104 is made, if at block 414, it is determined that the computing device 104 is to be rebooted (YES branch from block 414), then upon the computing device 104 restarting, the user identification data is obtained for the user logging in to the computing device 104 and the subsequent steps from block 406 onwards are executed. For example, in case the access rights or the user access level have been updated at the backend, for instance, at the AC device 102, based on an update in the access policy, while the user is logged into the computing device 104, the user identification data of the user may still be obtained and transmitted to the AC device 102. In such a case, based on the update in the access rights, the user may be prompted to restart the computing device 104, based on the boot initiation instruction sent to the computing device by the AC device 102 along with the determined access right. Therefore, the assessment of available access rights may happen intermediately, in addition to cases where the user may log in to the computing device 104 for the first time as explained previously. On the other hand, if at block 414, it is determined that the computing device 104 is not to be rebooted (NO branch from block 414), for example, because the computing device 104 has already automatically rebooted or reached block 414 after rebooting, then at block 416, the centralized access control of the I/O resources 302 is exercised by initiating the application of the access rights, for example, by implementing the access rights in the operating system of the computing device 104 after the operating system has booted.

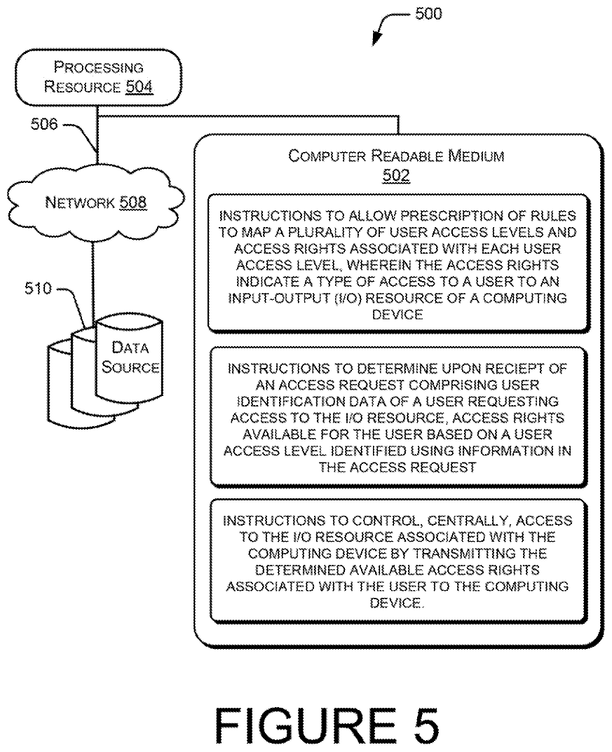

FIG. 5 illustrates a network environment 500 using a non-transitory computer readable medium 502 for centralized access control of one or more I/O resources 302 of the computing device 104, according to an example of the present subject matter. The network environment 500 may be a public networking environment or a private networking environment. In one example, the network environment 500 includes a processing resource 504 communicatively coupled to the non-transitory computer readable medium 502 through a communication link 506.

For example, the processing resource 504 may be a processor of a computing system, such as the AC device 102. The non-transitory computer readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer readable medium 502 through a network 508. The network 508 may be a single network or a combination of multiple networks and may use a variety of communication protocols.

The processing resource 504 and the non-transitory computer readable medium 502 may also be communicatively coupled to data sources 510 over the network 508. The data sources 510 may include, for example, databases and computing devices. The data sources 510 may be used by the database administrators and other users to communicate with the processing resource 504.

In one example, the non-transitory computer readable medium 502 includes a set of computer readable and executable instructions. The set of computer readable instructions, referred to as instructions hereinafter, may be accessed by the processing resource 504 through the communication link 506 and subsequently executed to perform acts for network service insertion.

For discussion purposes, the execution of the instructions by the processing resource 504 has been described with reference to various components introduced earlier with reference to description of FIG. 1 and FIG. 2.

On execution by the processing resource 504, the processing resource 504 may allow prescription of rules to map a plurality of user access levels and access rights associated with each user access level. In an example, the access rights may indicate a type of access to a user to the I/O resource 302 of the computing device 104. For instance, the type of access may be read-and-write access, read-only access, and no-access for the I/O resource 302.

Further, upon receipt, from the computing device 104, of an access request comprising user identification data of a user requesting access to the I/O resource 302, the access rights available for the user can be determined based on a user access level which can be identified using information, for instance, the user identification data, in the access request. Accordingly, the determined available access rights associated with the user can be transmitted to the computing device 104 to control, centrally, access to the I/O resource 302 associated with the computing device 104. In an example, the determined available access rights are transmitted to either the BIOS or the UEFI driver of the computing device 104. In addition, the processing resource 504 may transmit a boot initiation instruction to the computing device 104 along with the determined available access rights, so as to reboot the computing device 104 and implement the access rights, for example, in the operating system of the computing device 104 when the operating system boots upon reboot of the computing device 104.

Although aspects of centralized access control of the U/O resources 302 of a computing device 104 have been described in a language specific to structural features and/or methods, it is to be understood that the subject matter is not limited to the features or methods described. Rather, the features and methods are disclosed as examples of centralized access control of I/O resources 302 of a computing device 104.

I/We claim:

1. An access control device for centralized access control of input-output (I/O) resources, the central access control device comprising:
a processor, and
a memory coupled to the processor and storing instructions executable by the processor to:
allow definition of a user access level and an access right associated with the user access level, wherein the access right indicates a right to access an I/O resource of a computing device;
receive user identification data of a user attempting to gain access to the I/O resource of the computing device by logging into the computing device before booting of the computing device;
determine the access right available for the user based on a user access level identified for the user based on the user identification data; and
transmit the determined access right associated with the user to the computing device to permit access to the I/O resource to the user.

2. The central access control device as claimed in claim 1, wherein the I/O resource is one of a universal serial bus (USB) port, a USB Type-C port, a local area network (LAN) port, a High-Definition Multimedia Interface (HDMI) port, and an optical disk drive.

3. The central access control device as claimed in claim 1, wherein the determined set of access rights are transmitted to one of a Basic Input-Output System (BIOS) of the computing device and a Unified Extensible Firmware Interface (UEFI) driver of the computing device.

4. The central access control device as claimed in claim 1, wherein the processor is to transmit a boot initiation instruction to the computing device along with the determined access right.

5. A computing device comprising:
an input-output (I/O) resource;
a processor; and
a memory coupled to the processor and storing instructions executable by the processor to:
obtain user identification data of a user logging into the computing device to attempt to gain access to the I/O resource;
transmit, to a access control device, the user identification data;
obtain, from the access control device, an access right for the I/O resource available for the user based on the user identification data; and
apply the obtained access right to the computing device to centrally control access to the I/O resource.

6. The computing device as claimed in claim 5, wherein the I/O resource is one of a universal serial bus (USB) port, a USB Type-C port, a local area network (LAN) port, a High-Definition Multimedia Interface (HDMI) port, and an optical disk drive.

7. The computing device as claimed in claim 5, wherein the processor is to determine, based on the obtained access right, whether the computing device is to be restarted.

8. The computing device as claimed in claim 5, wherein the processor is to apply the access right by booting the computing device.

9. The computing device as claimed in claim 8, wherein the processor is to apply the obtained set of access rights using one of a Basic Input-Output System (BIOS) of the computing device and a Unified Extensible Firmware Interface (UEFI) driver of the computing device.

10. The computing device as claimed in claim 8, wherein the processor is to transmit the access request to the central access control device through a pre-boot network communicator capable of communicating with the central access control device before the booting of the computing device.

11. A non-transitory computer-readable medium comprising computer-readable instructions which, when executed by a processing resource, cause the processing resource to:
allow prescription of rules to map a plurality of user access levels and access rights associated with each user access level, wherein the access rights indicate a type of access to an input-output (I/O) resource of a computing device;
determine, upon receipt of an access request comprising user identification data of a user requesting access to the I/O resource, access rights available for the user based on a user access level identified from amongst the plurality of user access levels using information in the access request; and
control, centrally, access to the I/O resource associated with the computing device by transmitting the available access rights associated with the user to the computing device.

12. The non-transitory computer-readable medium as claimed in claim 11, wherein the I/O resource is one of a universal serial bus (USB) port, a USB Type-C port, a local area network (LAN) port, a High-Definition Multimedia Interface (HDMI) port, and an optical disk drive.

13. The non-transitory computer-readable medium as claimed in claim 11, wherein the access request is received from one of a Basic Input-Output System (BIOS) of the computing device and a Unified Extensible Firmware Interface (UEFI) driver of the computing device.

14. The non-transitory computer-readable medium as claimed in claim 11, wherein the available access rights are transmitted to one of a Basic Input-Output System (BIOS) of the computing device and a Unified Extensible Firmware Interface (UEFI) driver of the computing device.

15. The non-transitory computer-readable medium as claimed in claim 11 to cause the processing resource to transmit a boot Initiation instruction to the computing device along with the available access rights.
